(19) United States
(12) Patent Application Publication
(10) Pub. No.: US 2004/0193557 A1
(43) Pub. Date: Sep. 30, 2004

(54) Systems and methods for reducing ambiguity of communications

(76) Inventor: Jesse Dale Olsen, San Diego, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/397,031

(22) Filed: Mar. 25, 2003

(51) Int. Cl. G06F 15/18

(52) U.S. Cl. 706/1

(57) ABSTRACT

Systems and methods for reducing ambiguity of intended communications are provided. One such method comprises: receiving information corresponding to an intended communication; in response to an input by an operator, automatically determining whether the intended communication is ambiguous; and enabling the operator to resolve the ambiguity.

### BACKGROUND

Ambiguity is an inherent characteristic of virtually all languages. Typically, such ambiguity can be overcome during face-to-face communication through the use of body language, for example. However, when communications take place between people that are not face-to-face, ambiguity can lead to confusion, e.g., a communication may not be understood.

The globalization of communication networks tends to exacerbate ambiguity-caused confusion of text-based and verbal communications. Specifically, these networks enable communication among people that are remote from each other so that body language oftentimes is not communicated, i.e., when voice-only communication is used. Additionally, these networks enable communication between people whose primary languages can differ. Because of this, variations in idiomatic expressions and/or dialects can result in further confusion, particularly when a communication is translated from one language to another, such as through use of automated text-translation systems.

### SUMMARY

Systems and methods for reducing ambiguity of intended communications are provided. One such method comprises: receiving information corresponding to an intended communication; in response to an input by an operator, automatically determining whether the intended communication is ambiguous; and enabling the operator to resolve the ambiguity.

Another method comprises: receiving information corresponding to words; in response to an input by an operator, automatically determining whether each of the words has multiple meanings; enabling the operator to select a particular meaning for each of the words; and correlating the meanings selected with each of the words.

A system for reducing ambiguity of a communication comprises an unambiguation system. The unambiguation system is operative to: receive information corresponding to an intended communication; in response to an input by an operator, automatically determine whether the intended communication is ambiguous; and enable the operator to resolve the ambiguity.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

Reference is now made to the following drawings. Note that the components in the drawings are not necessarily to scale.

FIG. 1 is a schematic diagram depicting functionality of an embodiment of an unambiguation system.

FIG. 2 is a flowchart depicting functionality associated with an embodiment of an unambiguation system.

FIG. 3 is a schematic diagram of a computer or processor-based system that can be used to implement an embodiment of an unambiguation system.

FIG. 4 is a flowchart depicting functionality of another embodiment of an unambiguation system.

FIG. 5 is a schematic diagram of an embodiment of a graphical user interface (GUI) provided by the system of FIG. 3.

FIG. 6 is a schematic diagram of the GUI of FIG. 5.

FIG. 7 is a schematic diagram depicting an original text-based communication and associated linked, unambiguated communication.

FIG. 8 is a schematic diagram of another embodiment of GUI associated with an embodiment of an unambiguation system.

FIG. 9 is a schematic diagram depicting an original text-based communication, an associated linked, unambiguated communication and an associated translated, unambiguated communication.

### DETAILED DESCRIPTION

As will be described in greater detail here, systems and methods are provided that reduce the potential ambiguity of communications. By way of example, some embodiments provide an operator with an opportunity to select a particular meaning for a word of a text communication that is subject to multiple meanings. Once selected, the selected meaning can be linked to the ambiguous word. For instance, in some embodiments, the selected meaning can be provided as a retrievable comment embedded within the text that can be viewed by a reader if desired. Additionally or alternatively, the selected meaning can be substituted directly into the text for the ambiguous word.

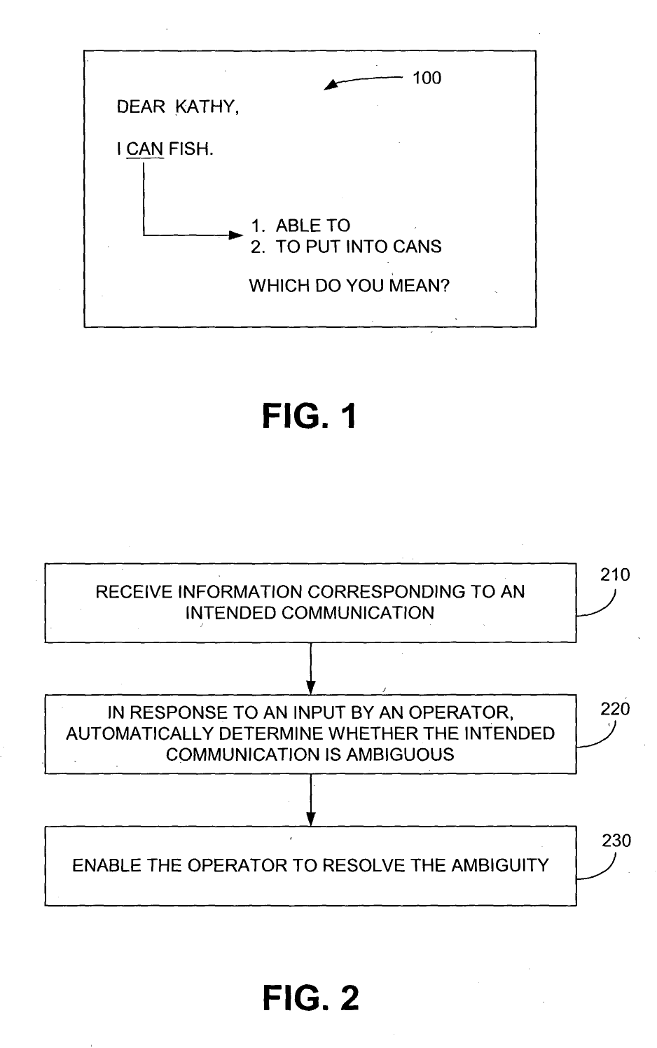

Referring now to the drawings, FIG. 1 is a schematic diagram depicting a representative text communication 100 in the form of an email. Note, the word “can” is ambiguous. Specifically, it is unknown whether the sender of the communication means that he “is able to” fish or whether he “puts fish into cans.”

FIG. 2 is a flowchart depicting functionality of an embodiment of an unambiguation system that can be used for reducing ambiguity of communications. As shown in FIG. 2, the functionality (or method) may be construed as beginning at block 210, where information corresponding to an intended communication is received. By way of example, the intended communication can correspond to an email or other form of text-based communication and/or information corresponding to a verbal communication. In block 220, a determination is made as to whether the intended communication is ambiguous. Specifically, a determination is made as to whether one or more words of the intended communication has multiple meanings. Typically, the determination is automatically initiated in response to an input by an operator as will be described in greater detail later. In block 230, the operator is enabled to resolve the ambiguity, such as by selecting a meaning for each of the identified words or groups of words.

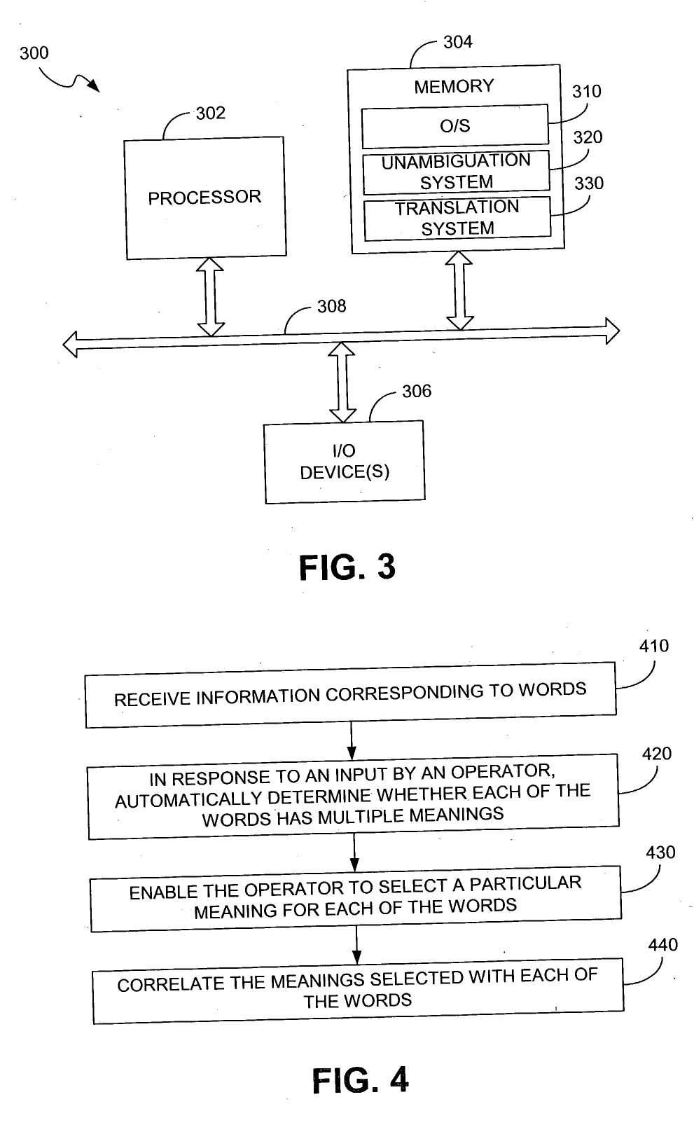

Typically, the functionality described with respect to FIG. 2 is implemented, at least in part, by an unambiguation system. Embodiments of unambiguation systems can be implemented in hardware, software and/or combination thereof An embodiment of an unambiguation system that is implemented in software is depicted schematically in FIG. 3, where the unambiguation system is associated with a computer or processor-based system 300.

Generally, computer 300 includes a processor 302, memory 304, and one or more input and/or output (I/0) devices 306 (or peripherals) that are communicatively coupled via a local interface 308. The software in memory 304 can include one or more separate programs, each of which comprises an ordered listing of executable instructions for implementing logical functions. In the example of FIG. 3, the software in the memory 304 includes an operating system (O/S) 310, an unambiguation system 320 and a translation system 330.

When an unambiguation system is implemented in software, it should be noted that the unambiguation system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. An unambiguation system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Functionality of the unambiguation system 320 of FIG. 3 is depicted in the flowchart of FIG. 4. As shown in FIG. 4, the functionality (or method) may be construed as beginning at block 410, where information corresponding to words is received. In block 420, a determination is made as to whether at least one of the words has multiple meanings. In block 430, an operator is enabled to select, with respect to each word identified as having multiple meanings, a particular meaning. Then, in block 440, the meaning selected for each of the words is correlated with the information received. Thus, potential ambiguity of the information may be resolved.

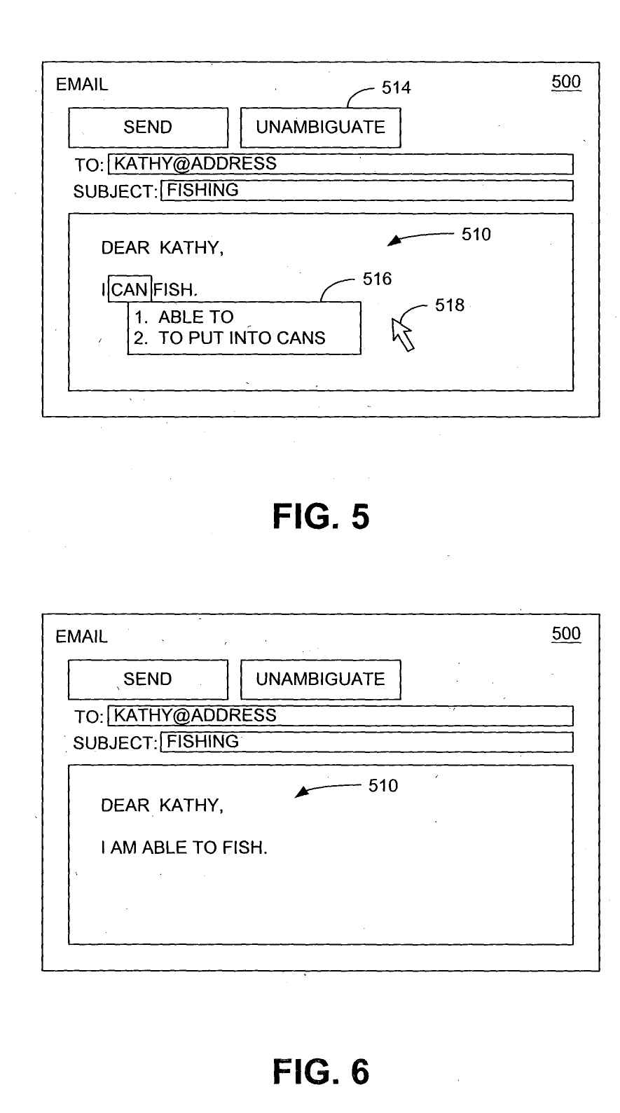

FIG. 5 is a schematic diagram depicting an embodiment of a graphical user interface (GUI) provided by a computer system, such as the computer system of FIG. 3. As depicted in FIG. 5, GUI 500 associated with an email application that enables an operator to send a text communication to a recipient.

In FIG. 5, the operator has input the message 510 “Dear Kathy, I can fish.” in window 512. In order to resolve the ambiguity of the message 510, the operator actuates the unambiguate button 514. In response to the actuation, the information contained in the message is analyzed.

In the example depicted in FIG. 5, it is determined that the word “can” is subject to multiple meanings. Note that the word “can” is highlighted and a drop-down menu 516 is presented. The operator is then able to select the desired meaning of the word “can,” such as by moving a corresponding cursor 518 and selecting the first meaning, i.e., “able to.” As shown in FIG. 6, the selected meaning has been substituted directly into the text of the intended communication or message 510.

In some embodiments, in contrast to directly substituting a meaning for a potentially ambiguous word(s), unambiguation systems can associate a selected meaning with a potentially ambiguous word such that the associated meaning is hidden from view until selected. For instance, the associated meaning may be displayed in a text box when a cursor is moved over the ambiguous word. By way of further example, a potentially ambiguous word could be highlighted, such as by a form of underlining. Additionally or alternatively, selected meanings can be displayed in-line. For instance, in the “I can fish” example, an unambiguation system could display “I can [am able to] fish.”

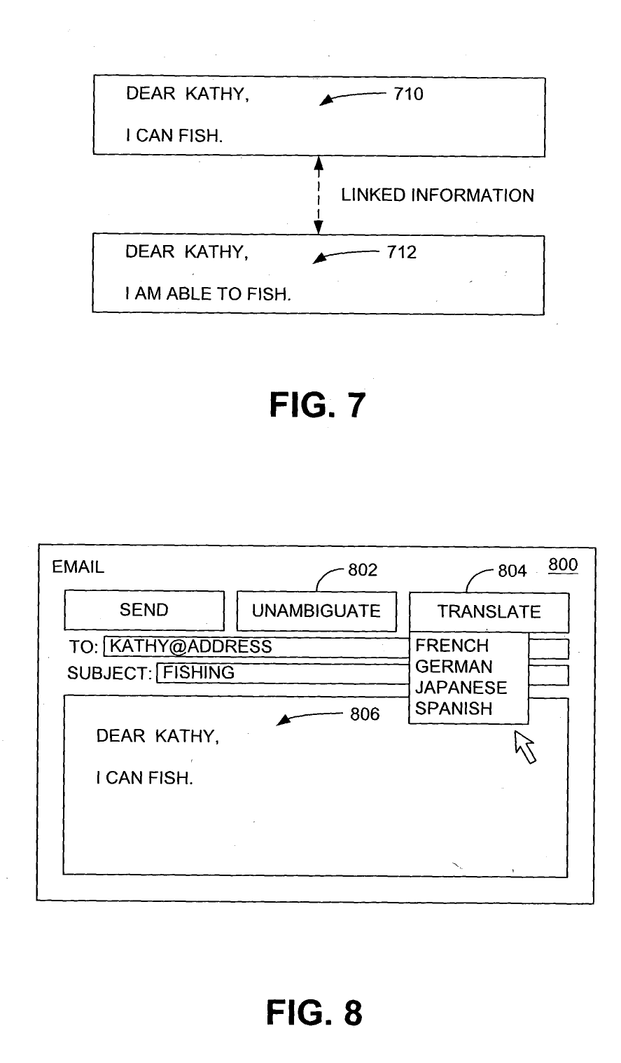

FIG. 7 schematically depicts a relationship between an intended communication 710 and a corresponding unambiguated communication 712, which includes operator-selected meanings for words identified as being potentially ambiguous. Note that in the embodiment depicted in FIG. 7, the unambiguated communication 712 includes the selected meaning substituted into the original text. In other embodiments, the unambiguated communication may only include the selected meaning(s) for word(s) designated as being ambiguous in the intended communication. For instance, in some embodiments, the unambiguated communication associated with intended communication 710 would include “able to” and a marker correlating the meaning to the word “can.”

In an embodiment such as that depicted in FIG. 7, a recipient of communication 710 can read “Dear Kathy, I can fish.” without viewing information associated with the unambiguated communication 712. However, if the recipient of the communication so chooses, the linked, unambiguated communication 712 can be viewed. Depending upon the embodiment, this can include viewing only the selected meaning(s) for the ambiguous word(s) and/or the entire unambiguated communication, which include the selected meaning(s) substituted into the original text.

Referring back briefly to the embodiment of the computer system of FIG. 3, note that a translation system 330 is provided. As depicted schematically in FIG. 8, such a translation system can be used to translate a communication from one language to another. As will now be described, an operator and/or recipient can use an unambiguation system in combination with a translation system to translate a communication from English to Spanish, for example.

As shown in FIG. 8, an embodiment of a GUI 800 is provided that facilitates interaction with an unambiguation system and a translation system. Specifically, GUI 800 includes both an unambiguate actuator 802 and a translate actuator 804. The unambiguate actuator 802 functions in a manner similar to that described before with respect to FIGS. 5 and 6. The translate actuator 804, upon actuation, enables an operator to select a language to which an intended communication is to be translated. In the example depicted in FIG. 8, the operator intends to have message 806 “Dear Kathy, I can fish,” translated into Spanish.

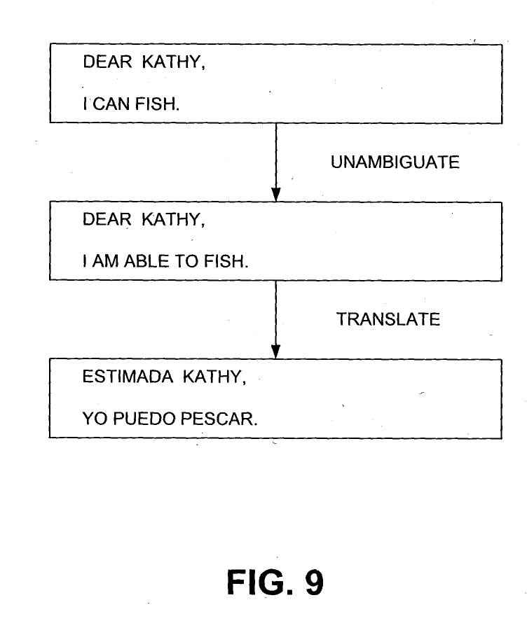

In order to translate the intended communication into Spanish, the intended communication is analyzed to determine whether any of the words are potentially ambiguous. As mentioned before, the communication exhibits ambiguity with respect to the word “can.” Thus, when the operator actuates translate actuator 804, the communication is resolved into an unambiguated communication, whereby a particular definition for the word “can” is attributed to the word “can.” As shown in FIG. 9, the unambiguated communication then is translated into Spanish. Note that actuation of the unambiguation actuator 802 was not required in the previous example because this embodiment defaults to using the functionality attributed to the unambiguation system when translation is desired. In other embodiments, it may be necessary to manually activate the unambiguation actuator, if desired, prior to activation of the translate actuator.

Note that in the above example, the intended communication “I can fish” was unambiguated with respect to English. That is, the English word “can” was identified as being ambiguous. Therefore, a particular English meaning was correlated with the word “can” in order to unambiguate the intended communication. Additionally or alternatively, an intended communication can be unambiguated with respect to a language other than the original language of the intended communication. For instance, an intended communication in English could be unambiguated with respect to Spanish. In particular, if the translation of an intended communication from English to Spanish results in one or more words that are ambiguous in Spanish, the intended communication in English could be considered ambiguous even though there is no ambiguity in English. Therefore, meanings could be presented to the operator in English for each word that is potentially ambiguous when translated to Spanish. Thus, when the intended communication is translated to Spanish, the translation is unambiguous in Spanish.

Also note that an intended communication can be unambiguated with respect to more than one language. By way of example, if the drafter of an intended communication anticipates that the intended communication may be required to be translated between any of five selected languages, the intended communication can be unambiguated with respect to the five selected languages. Therefore, translation from one of the languages to any of the other languages could take place without ambiguity.

It should be emphasized that many variations and modifications may be made to the above-described embodiments. By way of example, some embodiments can be operative to determine the intended correlation of adjectives and nouns. For instance, in the intended communication “books and cans that are red,” it is ambiguous as to whether both the books and the cans are red or whether only the cans are red. Additionally or alternatively, embodiments of an unambiguation system can determine the intended correlation between nouns and pronouns. By way of example, in the intended communication “Joe said that Fred didn't like his shoes,” it is ambiguous as to whether Fred doesn't like Joe's shoes or whether Fred doesn't like his own shoes. By correlating these words, such ambiguity can be resolved. All such modifications and variations are intended to be included herein within the scope of this disclosure and protected by the following claims.

1. A method for reducing ambiguity of an intended communication, comprising:
receiving information corresponding to an intended communication;
in response to an input by an operator, automatically determining whether the intended communication is ambiguous; and
enabling the operator to resolve the ambiguity.

2. The method of claim 1, wherein enabling comprises:
providing multiple meanings corresponding to at least a first word of the intended communication; and
enabling the operator to select one of the multiple meanings.

3. The method of claim 2, wherein the first word is a pronoun.

4. The method of claim 1, wherein automatically determining comprises:
automatically determining whether at least one word of the intended communication has multiple meanings.

5. The methods of claim 4, wherein enabling comprises:
displaying multiple meanings corresponding to the at least one word; and
receiving an input corresponding to an operator-selected one of the meanings.

6. The method of claim 5, wherein enabling further comprises:
substituting the operator-selected meaning for the at least one word.

7. The method of claim 5, wherein enabling further comprises:
linking the operator-selected meaning to the at least one word.

8. The method of claim 1, further comprising:
in response to an input by the operator, automatically translating the intended communication from a first language to a second language.

9. The method of claim 8, wherein ambiguity of the intended communication is resolved with respect to the second language.

10. A method for reducing ambiguity of a communication, comprising:
receiving information corresponding to words;
in response to an input by an operator, automatically determining whether each of the words has multiple meanings;
enabling the operator to select a particular meaning for each of the words; and
correlating the meanings selected with each of the words.

11. The method of claim 10, further comprising:
provide a graphical user interface (GUI); and
wherein enabling the operator to select a particular meaning for each of the words comprises enabling the operator to select one of the multiple meanings for each of the words via the GUI.

12. The method of claim 10, further comprising:
in response to an input by the operator, automatically translating the intended communication from a first language to a second language.

13. The method of claim 12, further comprising:
determining whether each of the words of the intended communication, which has been translated to the second language, has multiple meanings; and
enabling the operator to select a particular meaning for each of the words of the second language.

14. The method of claim 10, further comprising:
automatically determining whether each group of words of the intended communication has multiple meanings; and
enabling the operator to select a particular meaning for each group of the words.

15. A system for reducing ambiguity of a communication comprising:
an unambiguation system operative to:
receive information corresponding to an intended communication;
in response to an input by an operator, automatically determine whether the intended communication is ambiguous; and
enable the operator to resolve the ambiguity.

16. The system of claim 15, wherein the unambiguation system is stored on a computer-readable medium.

17. The system of claim 15, wherein the unambiguation system comprises:
logic configured to provide multiple meanings corresponding to at least a first word of the intended communication and to enable the operator to select one of the multiple meanings.

18. The system of claim 15, wherein the unambiguation system is further operative to provide a graphical user interface (GUI), the GUI being operative to display multiple meanings corresponding to at least a first word of the intended communication to the operator.

19. The system of claim 15, further comprising:
means for displaying multiple meanings corresponding to at least a first word of the intended communication to the operator.

20. The system of claim 15, further comprising:
a translation system communicating with the unambiguation system and operative to translate an intended communication from a first language to a second language.
